(19) United States
(12) Patent Application Publication
(10) Pub. No.: US 2005/0071443 A1
(43) Pub. Date: Mar. 31, 2005

(54) Software platform for the delivery of services and personalized content

(76) Inventors: Jai Menon, Alpharetta, GA (US); Donna Hodges, Cumming, GA (US); Kim Littrell, Marietta, GA (US); Chris Parsons, Alpharetta, GA (US)

Correspondence Address: MERCHANT & GOULD PC, P.O. BOX 2903, MINNEAPOLIS, MN, 55402-0903, US

(21) Appl. No.: 10/036,164

(22) Filed: Dec. 31, 2001

Related U.S. Application Data
(60) Provisional application No. 60/318,572, filed on Sep. 10, 2001.
(60) Provisional application No. 60/318,573, filed on Sep. 10, 2001.

(51) Int. Cl. G06F 15/173

(52) U.S. Cl. 709/223

(57) ABSTRACT

A software platform that supports the delivery of services and personalized content is provided. The software platform interfaces with an edge network and a distribution platform. The edge network is a computer network that distributes servers, routers and storage throughout the network. The software platform augments that physical capabilities of the edge network and provides a number of platform services. The distribution platform is a software platform that provides an interface to the platform services and the edge network.

### RELATED APPLICATIONS

This U.S. patent application claims priority to U.S. Provisional Patent Application Ser. No. 60/318,572 entitled “Communication Network” and to U.S. Provisional Patent Application Ser. No. 60/318,573 entitled “e-Platform and Connectivity Platform” both filed Sep. 10, 2001 and both of which are incorporated herein by reference.

This U.S. patent application is related to U.S. patent application Ser. No. ______ entitled “Distributed Computer Network for the Delivery of Services and Personalized Content” (attorney docket no. 36968/263593) and U.S. patent application Ser. No. ______ entitled “Distribution Platform for the Delivery of Services and Personalized Content” (attorney docket no. 36968/263592) both filed concurrently herewith and both of which are incorporated herein by reference.

### TECHNICAL FIELD

This invention relates in general to computer software, and more particularly to computer software that supports the delivery of services and personalized content.

### BACKGROUND

Information, software, and services are available via networks, such as the Internet or other large networks. In many cases, the problem is not availability, but relevancy. For example, information about major league baseball is readily available on the Internet. The problem is filtering the available information to find the relevant information. Some information providers allow a user to specify the type of information desired or the manner of delivery desired by accepting search criteria or a profile from the user. However, the burden is upon the user to submit the profile or search criteria. Moreover, if the user's preferences change, then the user must submit another profile or search criteria to change the delivery of the information. It would be more convenient if the user's preferences, including changes in the user's preferences, could be determined based on how the user accesses information. Therefore, there is a need to determine user preferences based on user action.

Information providers and software providers want to provide relevant information and software to users in a manner that the users find most useful. Profiles and search criteria submitted by the users can be evaluated to determine what information and manners of delivery are most relevant. However, as in the case of user preferences, it would be more effective if the relevant information and delivery mechanisms could be determined by actual usage. Therefore, there is a need to identify and deliver relevant information and software based on a user's actions.

In addition to relevancy, information and software providers are also concerned about reliability, security, and performance. Often times a provider desires to focus its efforts on developing its unique product, for example a news service or a software application, instead of expending efforts developing supporting services, such as security. In addition, a provider may want to deliver information to a variety of devices, such as personal computers, personal digital assistants, and wireless telephones, but may not want to develop the software and services needed to interface with each of the devices.

Currently services can be provided to an application program through an API (Application Programming Interface). Although an API allows the application program to obtain services by invoking another program, the application program must be written using the specific API required by the program. If the application program is to be executed on a different platform that uses a different set of API's, then the application program must be rewritten using a new set of API's. It would be easier to develop an application program that could run on a number of different platforms if the application program did not need to include platform specific API's. Thus, there is a need to provide a platform that offers a variety of services and that does not require the use of platform specific API's.

### SUMMARY

The present invention meets the needs described above by providing a distributed computer network that supports the delivery of services and personalized content. The present invention provides an edge network, an edge platform and a distribution platform. The edge network is a computer network with servers, routers and storage (collectively referred to herein as a point of presence) distributed throughout the network. The edge platform is a software platform that augments that physical capabilities of the edge network and provides a number of platform services. The distribution network is a software platform that provides an interface to the platform services and the edge network.

The edge network includes a central point of presence or an electronic business center that is connected to a number of regional points of presence. Each regional point of presence is connected to a number of edge points of presence. Each edge point of presence is connected to one or more user gateways that provide service to a user or client. The capabilities and capacities of the servers, routers and storage devices in the edge network are graduated so that the capabilities and capacities of a point of presence closer to the central point of presence are greater than those of a point of presence closer to the edge of the network.

An edge point of presence can monitor a user's actions to identify content that is relevant to the user. The edge point of presence can also monitor the user's actions to determine the context for the delivery of information. A user may use a variety of devices to receive information, including a personal computer, an electronic mail appliance, and a wireless telephone. By knowing what device(s) the user is currently using, information can be provided to the user in the proper context.

The edge platform includes an edge network services layer, an integration layer and a number of platform components. The edge network services layer interfaces with the edge network. The integration layer interfaces with the edge network services layer and the platform components and includes a network management layer and a service management layer. The network management layer provides control, provisioning, management and monitoring of the servers, routers and storage devices in the edge network. The service management layer provides software services to support the platform components.

The distribution platform provides an interface that allows users and application programs to fully utilize the edge platform and the edge network. The distribution platform includes a peer to peer component and a grid component. The peer to peer component allows information and services to reside anywhere in the edge network. The grid component provides control and management of the information and the services

The distribution platform provides a registration system so that an application program can register for and receive information or services without having to implement a platform specific API (Application Programming Interface). Once the application program registers for a service, the distribution platform monitors the application program as it executes and gathers any data which is needed to provide the information or service.

These and other aspects, features and advantages of the present invention may be more clearly understood and appreciated from a review of the following detailed description of the disclosed embodiments and by reference to the appended drawings and claims.

### BRIEF DESCRIPTION OF THE DRAWINGS

FIG. 1 is a block diagram illustrating an edge network, in accordance with an embodiment of the invention.

FIG. 2 is a block diagram illustrating an edge platform, in accordance with an embodiment of the invention.

FIG. 3 is a block diagram illustrating the use of platform components, in accordance with an embodiment of the invention.

FIG. 4 is a block diagram illustrating the edge network, the edge platform and a distribution platform, in accordance with an embodiment of the invention.

### DETAILED DESCRIPTION

The present invention is directed to a system that provides relevant information to a user, as well as services to an application program. As used herein the term information includes data, software, services and any other type of information or product that can be delivered via a network. Briefly described, the system includes an edge network, an edge platform and a distribution platform. The edge network is a computer network with servers, routers and storage distributed throughout the network. The edge platform is a software platform that augments the physical capabilities of the edge network and provides a number of platform services. The distribution platform is a software platform that provides an interface to the platform services and the edge network.

In one embodiment, the edge network, the edge platform and the distribution platform utilize an existing telecommunications network. Telecommunications networks have traditionally provided reliable voice and data connections to users. The use of the telecommunications network as part of the system allows information providers to take advantage of the traditional strengths of the telecommunications network to provide information to users. For example, the ordering, provisioning, billing, and services provided by a telecommunications network can be used to support similar services for information providers.

Computer Environment

The present invention may be embodied in a computer or use a computer for implementation. A brief description of an exemplary computer or computer system follows. A computer system's operation is described herein largely in terms of methods or processes. Such a method or process generally is a sequence of computer-executed steps leading to a desired result. These steps typically require physical manipulations of physical quantities. Usually, these quantities take the form of electrical, magnetic, or optical signals capable of being stored, transferred, combined, compared, divided, or otherwise manipulated. These signals are generally referred to as bits, values, elements, symbols, characters, terms, numbers, records, files, data, information, or the like. These terms correspond to physical quantities for computer operations, and these terms are conventional labels applied to physical quantities that exist within and during operations of the computer system. Operations within the computer system are often referred to by such terms as adding, comparing, moving, dividing, etc. These terms are often associated with operations performed by a person. No involvement of a person is necessary or even desirable in the context of these operations within the computer system. The operations are machine operations that may be performed in conjunction with a person who interacts with the computer system.

The computer system and the processes described herein are unrelated to and are not limited to any particular computer system or apparatus. Various types of general purpose machines may be used with the processes, programs, and methods described herein. Alternatively, or in addition, specialized machines or apparatus may be constructed to perform the processes, programs, or methods described herein. For example, dedicated computer systems with hard-wired logic or programs or applications stored in non-volatile memory may be constructed for use with the exemplary embodiments.

Generally, a computer system such as may be used in the exemplary embodiments of the present invention includes a central processing unit (CPU) that operates the computer system in conjunction with a graphical user interface-based operating system to retrieve, process, store, and display data. In some cases, the computer system does not include a graphical user interface because the computer system interfaces with other computers or machines rather than displays data or otherwise interacts directly with a person. The CPU communicates, by means of control, address, and data signals, with the operating system and with the remaining components of the computer system through a system bus. The operating system includes a set of computer programs that control the internal functions of the computer system, thereby allowing the computer to run methods or processes which may be referred to as software, programs, application software, or application programs. The operating system is installed in a storage device, such as a hard disk drive, a floppy disk drive, a computer disk (CD) disk drive, or a ROM chip. During initialization (boot up) of the computer system, the operating system is loaded in a system memory.

The system memory of the computer system includes an application program that is loaded from a computer-readable medium such as the hard disk drive, the floppy disk drive, or the CD disk drive. The system memory also is a computer-readable medium. The application program operates in conjunction with the operating system to provide a graphical user interface (GUI). The system memory also includes a basic input/output system (BIOS) or program with the operating system. The BIOS supplies the device-level control or support services for the primary input/output devices of the computer during the initialization process. After initialization, the BIOS accepts requests from the application programs and from the operating system running on the computer system. The BIOS performs input/output services as requested by those programs.

Peripheral ports are generally provided on the system bus for receiving and transmitting data. Such data may be received and transmitted via a user interface. The user interface includes a keyboard and an input device for entering data. An input device may include a mouse, a trackball, track pad, or any other pointing device for positioning a cursor on a computer screen. Data is graphically displayed on a monitor. Data or information also may be received or transmitted via an interface that is used to program and/or test wireless units during the course of their manufacture.

Methods or programs and other information such as data relating to customers, subscribers, carriers, mobile switching centers, directory numbers, and translation of directing numbers relating to exemplary embodiments of the present invention may be included in the computer system and in particular included as part of an application program used by the computer system or a database or other memory or storage unit associated with the computer system.

Edge Network

The edge network is a distributed computer network. The edge network includes a central repository or electronic business center. The central repository is connected to collections of servers, routers and storage devices distributed throughout the network. The capabilities and capacities of the servers, routers and storage devices are graduated so that the capabilities and capacities of the devices closer to the central repository are greater than those further away. The terms closer and further away are used in a logical sense, and do not necessarily reflect the physical positioning of the devices. By providing a continuum of servers, routers and storage devices throughout the network, information is provided more efficiently to the users at the endpoints of the network. Moreover, the continuum distributes intelligence throughout the network which can be used to provide personalization services.

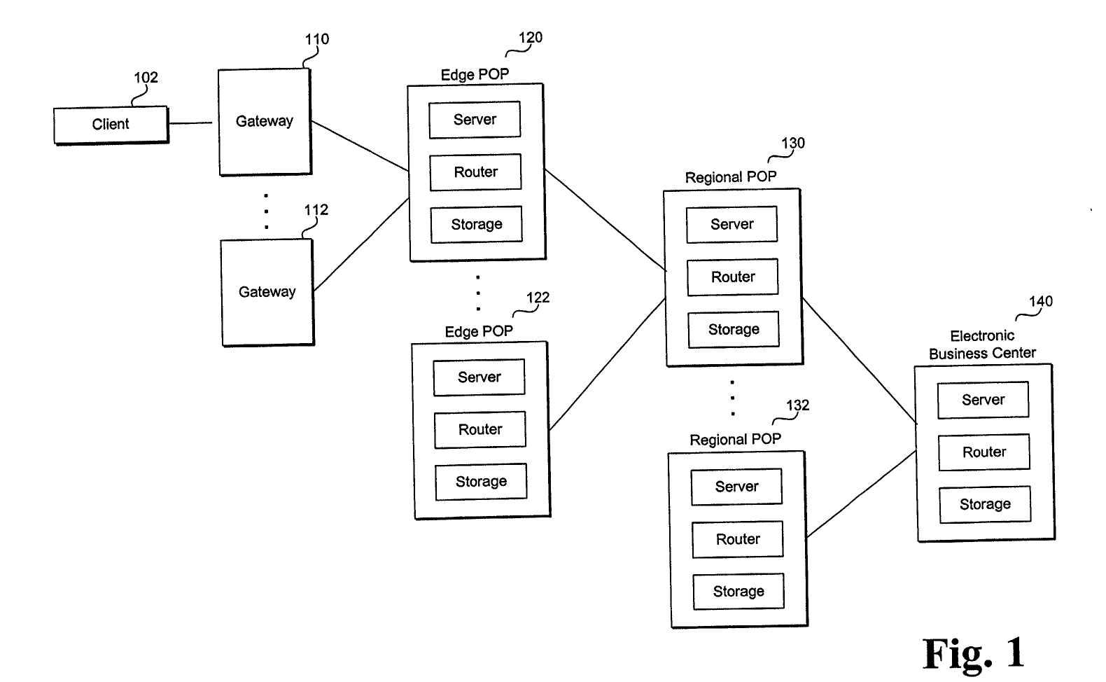

FIG. 1 illustrates the distribution of servers, routers and storage devices throughout the network. The collection of a server, router and storage device at a single point in the network is referred to herein as a point of presence (“PoP”). In one embodiment, the edge network is implemented using an existing telecommunications network that includes IP connectivity, optics and next generation switching components to provide increased bandwidth. In this embodiment, a point of presence can be implemented as a central office switch so that the point of presence includes the functions associated with a central office switch, as well as the functions associated with a server, a router and a storage device.

FIG. 1 includes a central PoP 140 (also referred to herein as an electronic business center), a number of regional PoP's 130, 132 and a number of edge PoP's 120, 122. The central PoP maintains application programs and information and distributes the application programs and information as needed. The central PoP includes server, router and storage capabilities. The central PoP 140 is connected to a number of regional PoP's 130, 132. Each regional PoP also includes server, router and storage capabilities. However, a regional PoP provides fewer capabilities and less capacity than the central PoP. Each regional PoP 130 is connected to a number of edge PoP's 120, 122. The edge PoP's provide fewer capabilities and less capacity than the regional PoP's. Each edge PoP 120 is connected to one or more user gateways 110, 112 that provide service to a user or client 102. The connection between an edge point of presence and a gateway can be a telephone line connection, wired or wireless, a cable connection, an optical connection or any other suitable connection. The client can connect to the gateway using a variety of devices, including telephone equipment, both wired and wireless, personal computers, personal digital assistants, interactive televisions, gaming consoles, electronic mail appliances or any other suitable device.

In one embodiment, a server at the central PoP provides enterprise scale applications and disaster recovery services, a server at a regional PoP provides e-mail server, domain name and network control services, and a server at an edge PoP provides security and personalization services. A router at the central PoP supports core routing, IP switching and firewalls, a router at a regional PoP supports core routing and MPLS (MultiProtocol Label Switching) and a router at an edge PoP supports edge routing. The storage at the central PoP is used to provide storage on demand, the storage at a regional PoP is used to store directories and local content, and the storage at an edge PoP is used to provide caching and store personalized content.

As an example, an edge PoP can cache information and store personalized content for a user's personalized web page. If the user creates a personalized web page that includes news, weather, sports and stock information, then some of the information may be cached at the edge PoP. Caching information at the edge PoP stores the information closer to the user and relieves congestion at the central PoP. The cached information is updated either periodically, in response to a trigger or upon detection or receipt of another indicator. The edge PoP can also store personalized content for the web page.

An edge PoP can monitor a user's actions to identify content that is relevant to the user. For example, if a user requests information about major league baseball from an information provider, the information provider may provide information about all the major league teams. However, if the edge PoP determines that the user typically only reviews information about three teams, then the user's preference information or profile is updated to reflect that the user is most interested in information about those three teams. The preference information or profile is typically maintained by the edge PoP. The preference information is used to provide information on the three relevant teams to the user in a manner that reflects that the user is most interested in that information. For example, the information on the remaining teams may not be initially displayed or may be displayed less prominently. In this manner, the user receives personalized information.

The edge PoP can also monitor the user's actions to determine the context for the delivery of information. A user may use a variety of devices to receive information, including a personal computer, an electronic mail appliance, and a wireless telephone. By knowing what device(s) the user is currently using, information can be provided to the user in a manner that is both appropriate and timely. For example, the user can designate a message from a particular person as a high priority message. A high priority message is one that should be delivered so that the message is received and read by the user as quickly as possible. If a high priority message is sent to the user, then the message should be delivered to the user via the device that the user is currently using. If the user is logged on to an electronic mail appliance, then the message should be delivered to the electronic mail appliance, rather than to another device that the user is not currently using. In this manner the message has the best chance of being timely received and read by the user. Instant messaging can be handled in a similar manner so that the user receives an instant message on the device the user is currently using.

User actions can be monitored by the routers at the edge PoP. A router examines the headers of the packets transmitted via the edge PoP to determine preferences and context, such as what information the user is accessing, what device the user is using to access the information, and what time of day the user is accessing the information.

The PoP's can be used to aggregate information from a number of users. The information may reflect how users are using the information provided or the most common devices used to receive the information. Each edge PoP aggregates information from the users connected to it. In turn, each regional PoP aggregates information from the edge PoP's connected to it. Finally, the central PoP aggregates the information from each of the regional PoP's. The aggregated information can be used by an information provider to design new products or services or improve upon existing products and services.

Edge Platform

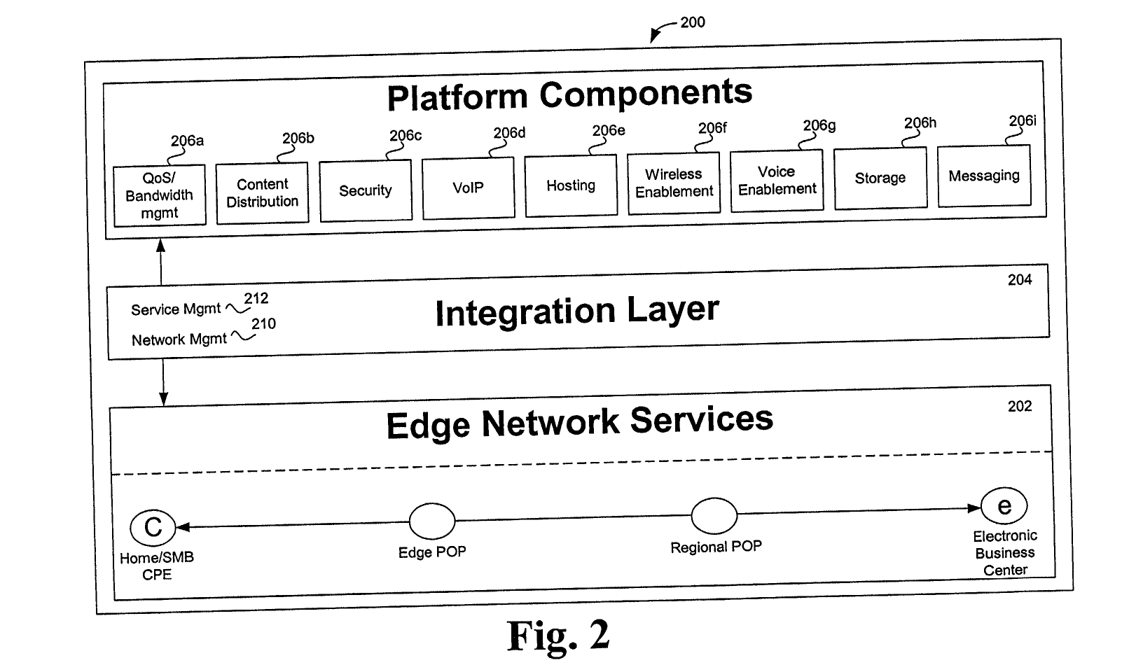

The physical capabilities of the edge network are accessed through a software platform referred to herein as the edge platform. FIG. 2 illustrates an exemplary edge platform 200. The edge platform includes an edge network services layer 202, an integration layer 204 and a number of platform components 206a, 206b, . . . 206i. The edge network services layer interfaces with a physical network, such as the edge network described above. The integration layer interfaces with the edge network services layer and the platform components and includes a network management layer 210 and a service management layer 212. The network management layer provides control, provisioning, management and monitoring of the servers, routers and storage devices in the edge network. The service management layer provides software services to support the platform components. For example, the service management layer provides a storage component 206h with a bundle of services, also referred to herein as a capability, to support life-cycle services, such as the initial configuration, installation, activation, update, and de-activation of storage for both server side and client side storage. The service management layer also provides policy management services. For the storage component, the policy management services include paging a service technician if a switch port fails or reallocating bandwidth if response time falls below a service level agreement (“SLA”). Policy management services also include digital rights management.

In addition to storage, the platform components provide other support services, as well as user interface services. The platform components include quality of service (“QoS”)/bandwidth management 206a, content distribution 206b, security 206c, voice over Internet protocol (“VoIP”) 206d, hosting 206e, wireless enablement 206f, voice enablement 206g and messaging components 206i. The bandwidth management component supports service level agreements (“SLA's”). The content distribution component supports the distribution of information to users. The security component provides secure interconnections. The VoIP component provides VoIP interconnections. The hosting component provides hosting services. The wireless enablement component provides a wireless interface and the voice enablement component provides a voice interface. The storage component provides storage services and the messaging component supports messaging services. As will be apparent to those skilled in the art, additional and/or different platform components than those illustrated in FIG. 2 can be used.

The platform components can be used in a number of different ways. One way is for an application program to access the component through an interface, such as an API. For example, an application program can access the storage component for backup and recovery services. Another way is for an application program to access the component by registering with the distribution platform, as described in more detail below. In addition a user can access the component directly. For example, a user can use the storage component to obtain automated backup services or to store content. The component can also be used to provide hosting services. For example, the storage component can be used to provide backup and recovery services and storage for an application program hosted on the central PoP.

The platform components can be used to provide a user interface. For example, the voice enablement component can be used to provide a voice interface and the wireless enablement component can be used to provide a wireless interface.

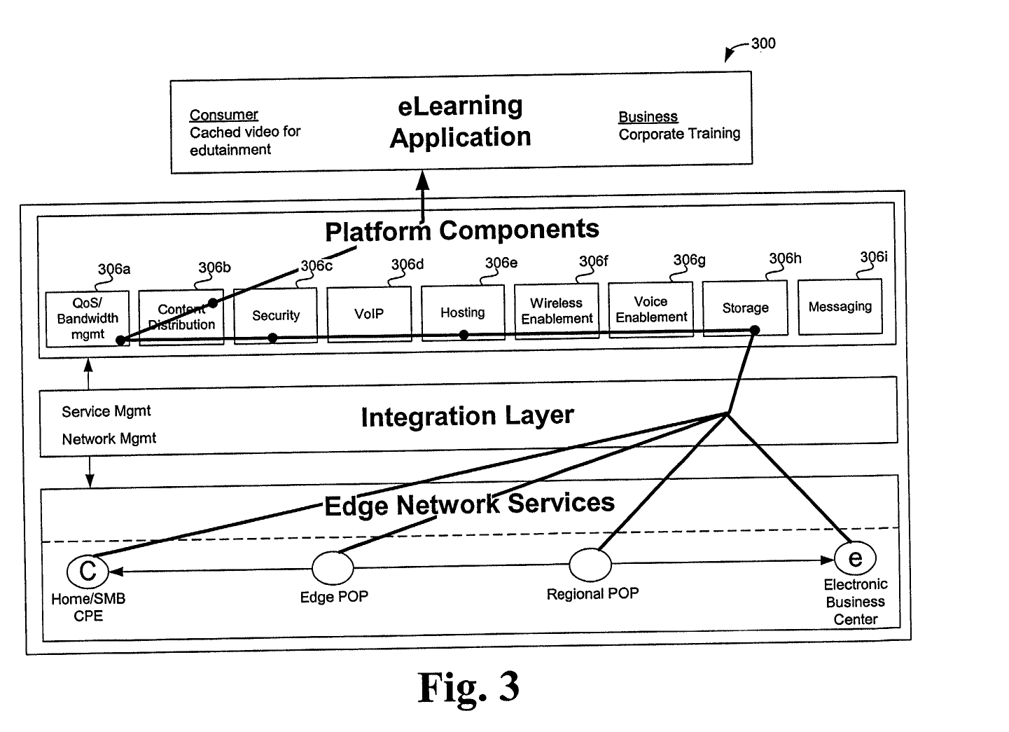

The platform components can be used alone or in combination. FIG. 3 illustrates an electronic learning or eLearning application 300 that uses the bandwidth management component 306a, the content distribution component 306b, the security component 306c, the hosting component 306e and the storage component 306h. Examples of an electronic learning application include cached video for edutainment or corporate training. FIG. 3 also illustrates that the electronic learning application uses information and programs distributed throughout the edge network.

Distribution Platform

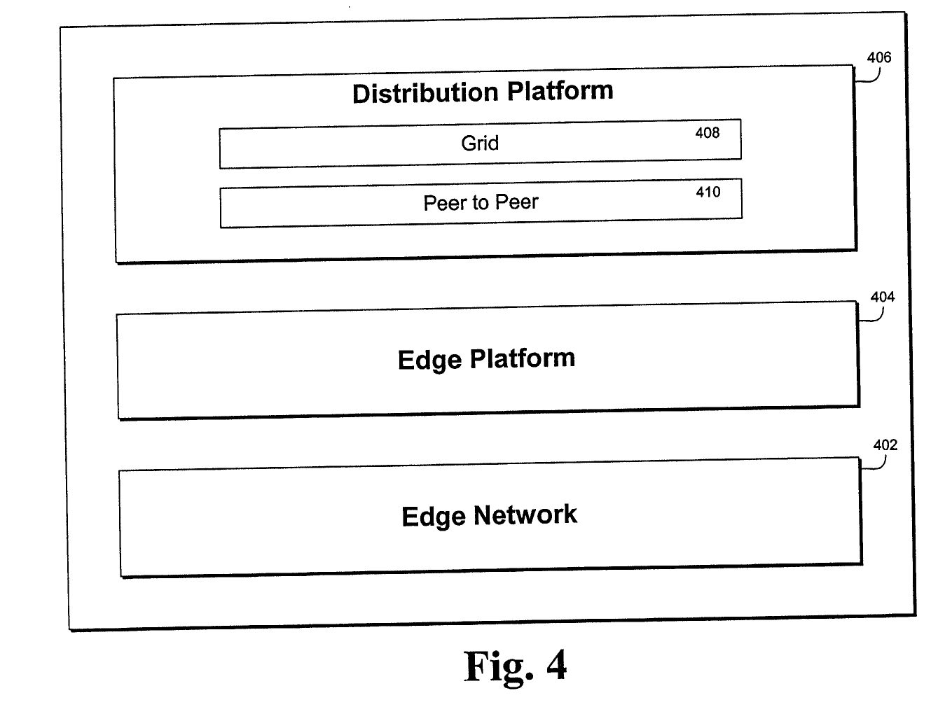

The distribution platform provides an interface that allows users and application programs to fully utilize the edge platform and the edge network. FIG. 4 illustrates the relationship between the edge network 402, the edge platform 404 and the distribution platform 406. The distribution platform includes a peer to peer component 410 and a grid component 408. The peer to peer component allows information and services to reside anywhere in the edge network. The grid component provides control and management of the information and the services.

Unlike prior systems, an application program does not need to be hosted on the edge platform or to use an edge platform API to access information or services available on the edge network. The distribution platform provides a registration system so that an application program can register for and receive the information or service. Once the application program registers for a service, the distribution platform monitors the application program as it executes and gathers any data which is needed to provide the information or service.

The information or service can be associated with an edge platform component or can reside on a PoP in the edge network. For example, an application program can request billing services by registering for the billing service and defining billing events. A gaming application may define the playing of an on-line game, the delivery of a game, and the delivery of an update to a game as billing events. If so, then the distribution platform monitors the application program and when a billing event, such as a request for an online game occurs, the distribution platform obtains billing information from the user. The application is not required to implement a special API to obtain the billing service. In the exemplary embodiment discussed herein, the billing service resides in the network management layer.

In another example, an application program can request wireless enablement so that the program can be accessed by a user using a wireless device without the application program being specifically written for a wireless device. The distribution platform also can provide user management services, such as user registration and user access rights.

The distribution platform also supports SLA's or service level agreements. An SLA is an agreement that defines a type of service and the acceptable parameters for the service. For example, some applications may require greater bandwidth at particular times. If so, then the application can request and obtain the needed bandwidth via an SLA that provides dynamic bandwidth adjustment. As described in the foregoing paragraphs, the application requests bandwidth management and identifies the events that require greater bandwidth.

Once an application program registers with the distribution platform, the distribution platform can provide publication or advertising services that target a user likely to be interested in the program by comparing the user's preference information with the information received from the application program. The user's preference information can be information supplied by the user or information obtained by monitoring the user's actions. The user's preference information is used so that a user receives notice of application programs that are relevant to them. The notice can be provided via an on-line directory or via an advertisement.

The distribution platform also supports the distribution of information and services throughout the edge network. Use of the edge network reduces latency because information and services can reside on the PoP's distributed throughout the network rather than only at a central location. The distribution platform matches information and/or services requested by a user with the appropriate PoP. For example, information associated with an edge PoP may be used by a particular user, whereas information associated with a regional PoP may be used by a number of users.

Additional alternative embodiments will be apparent to those skilled in the art to which the present invention pertains without departing from its spirit and scope. Accordingly, the scope of the present invention is described by the appended claims and is supported by the foregoing description.

1. A computer readable medium having computer executable components, comprising:
an edge network services component that provides an interface to a network, the network including a central point of presence, a plurality of regional points of presence connected to the central point of presence and a plurality of edge points of presence, each edge point of presence connected to a regional point of presence and at least one user location;
an integration component that interfaces with the edge network services component and a plurality of platform components, the integration component including network management services for the central point of presence, the regional points of presence and the edge points of presence and including platform component support services for the plurality of platform components; and
the plurality of platform components, each platform component associated with a service.

2. The computer readable medium of claim 1, wherein a first platform component associated with a first service and a second platform component associated with a second service are used in combination to provide the first service and the second service to an application program.

3. The computer readable medium of claim 1, wherein one of the platform components is a voice component that provides a voice interface to voice device.

4. The computer readable medium of claim 1, wherein one of the platform components is a wireless component that provides a wireless interface to a wireless device.

5. A computer readable medium having computer executable components, comprising:
an edge network services component that provides an interface to a network;
an integration component that interfaces with the edge network services component and a plurality of platform components, the integration component including network management services and platform component support services; and
the plurality of platform components, each platform component providing a service, wherein an application program utilizes a platform component to provide a user interface service.

6. The computer readable medium of claim 5, wherein one of the platform components is a wireless component that provides a wireless user interface for the application program.

7. The computer readable medium of claim 5, wherein one of the platform components is a voice component that provides a voice user interface for the application program.

8. The computer readable medium of claim 5, wherein the application program utilizes a second platform component to provide a support service.

9. The computer readable medium of claim 8, wherein the second platform component is a security component that provides a secure interconnection for the application program.

10. The computer readable medium of claim 8, wherein the second platform component is a storage component that provides storage for the application program.

11. The computer readable medium of claim 8, wherein the second platform component is a bandwidth management component that provides dynamic bandwidth adjustment for the application program.

12. A platform for hosting an application program, comprising:
an edge network services layer that interfaces to a network, the edge network services layer operative to identify information that is relevant to a user and a device that the user is using to access the network;
an integration layer that includes a service management layer that interfaces with the edge network services layer and a network management layer that interfaces with a plurality of platform components; and
the plurality of platform components, wherein the application program utilizes a platform component to obtain a support service.

13. The platform of claim 12, wherein the edge network services layer monitors a user's actions to identify information that is relevant to the user.

14. The platform of claim 12, wherein the platform hosts a plurality of application programs written for different platforms.

15. The platform of claim 12, wherein one of the platform components is a security component that provides secure interconnections for the application program.

16. The platform of claim 12, wherein the application program utilizes the platform components to provide a user interface service.

17. The platform of claim 16, wherein the edge network services layer identifies a wireless device as the device that the user is using to access the network and wherein one of the platform components is a wireless component that provides a wireless user interface for the application program.

18. The platform of claim 16, wherein the edge network services layer identifies a voice device as the device that the user is using to access the network and wherein one of the platform components is a voice component that provides a voice user interface for the application program.

19. The platform of claim 12, wherein the edge network services layer identifies selected information as the information that is selected to the user and wherein one of the platform components is a content distribution component that identifies the selected information to the application program.

20. The platform of claim 12, wherein a portion of the network includes a public switched telephone network.

21. The platform of claim 12, wherein the network includes:
a central point of presence, the central point of presence including a central server, a central router and central storage;
a plurality of regional points of presence connected to the central point of presence, each regional point of presence including a regional server, a regional router and regional storage; and
a plurality of edge points of presence, each edge point of presence including an edge server, an edge router and edge storage and each edge point of presence connected to one of the regional points of presence and at least one user location.
